(19) United States
(12) Patent Application Publication
(10) Pub. No.: US 2015/0169678 A1
(43) Pub. Date: Jun. 18, 2015

(54) METHOD AND APPARATUS FOR OBTAINING NUMBER OF VISITS OF A USER GENERATED CONTENT

(71) Applicants: Haiyang TAO, Shenzhen (CN); Lixian XIAO, Shenzhen (CN); Xingcai JIANG, Shenzhen (CN); Ming TIAN, Shenzhen (CN); Yunni FAN, Shenzhen (CN); Lihua HUANG, Shenzhen (CN)

(72) Inventors: Haiyang TAO, Shenzhen (CN); Lixian XIAO, Shenzhen (CN); Xingcai JIANG, Shenzhen (CN); Ming TIAN, Shenzhen (CN); Yunni FAN, Shenzhen (CN); Lihua HUANG, Shenzhen (CN)

(21) Appl. No.: 14/626,862

(22) Filed: Feb. 19, 2015

Related U.S. Application Data
(63) Continuation of application No. PCT/CN2013/087888, filed on Nov. 27, 2013.

(30) Foreign Application Priority Data
Mar. 27, 2013 (CN) 201310101227.0

(51) Int. Cl. G06F 17/30; H04L 29/06

(52) U.S. Cl. CPC G06F 17/30424; H04L 67/42

(57) ABSTRACT

According to an example, a client transmits to a server a querying request for querying number of visits of a UGC. The server obtains the number of visits of the UGC according to retrieved times of the UGC in a UGC system and provides the number of visits to the client. The client displays the number of visits of the UGC in association with the UGC.

### CROSS-REFERENCE TO RELATED APPLICATIONS

This application is a continuation of International Application No. PCT/CN2013/087888, filed on Nov. 27, 2013. This application claims the benefit and priority of Chinese Patent Application No. 201310101227.0, filed Mar. 27, 2013. The entire disclosures of each of the above applications are incorporated herein by reference.

### FIELD

The present disclosure relates to computer and Internet data processing techniques, and more particularly, to a method and an apparatus for obtaining number of visits of a user generated content (UGC).

### BACKGROUND

At present, users are both browsers and creators of website contents. The contents created by network users are referred to as user generated content (UGC), e.g., microblogs distributed by the users.

A website system on which user can post UGC is usually referred to as a UGC website system, e.g., microblog system, social network service (SNS) system, social forum system, knowledge sharing system, etc.

In a conventional UGC system, technical parameters for evaluating a spread range of a UGC generally include forwarding times of the UGC, number of comments of the UGC, number of likes, etc.

### SUMMARY

According to an example of the present disclosure, a method for obtaining number of visits of a UGC by a server is provided. The server includes an interface module, an access module and a storage module. The method includes:

receiving, by the interface module, a querying request transmitted by a client for querying number of visits of a UGC, wherein the querying request carries an identifier of the UGC;

obtaining, by the interface module, the number of visits of the UGC from the storage module according to the identifier of the UGC; wherein the number of visits of the UGC is stored in the storage module and is updated according to UGC number-of-visits information of the UGC generated by the access module, the access module generates the UGC number-of-visits information according to UGC retrieving action information obtained from a background server of a UGC system; and

returning, by the interface module, the obtained number of visits of the UGC to the client, such that the client displays the number of visits of the UGC in association with the UGC.

According to another example of the present disclosure, a server for obtaining number of visits of a UGC is provided. The server includes:

one or more processors;

a memory; and

one or more program modules stored in the memory and to be executed by the one or more processors, the one or more program modules include:

an access module, adapted to obtain UGC retrieving action information, generate number-of-visits information according to the UGC retrieving action information and transmit the generated UGC number-of-visits information to a storage module; wherein the UGC number-of-visits information includes an identifier of the UGC and number of visits of the UGC;

the storage module, adapted to receive the UGC number-of-visits information transmitted by the access module, and update number of visits of the UGC stored in the storage module according to the UGC number-of-visits information; and

an interface module, adapted to receive a querying request carrying the identifier of the UGC from a client, obtain the number of visits of the UGC from the storage module according to the identifier of the UGC, and return the number of visits to the client, such that the client displays the number of visits of the UGC in association with the UGC.

According to still another example of the present disclosure, a non-transitory computer-readable storage medium including a set of instructions for obtaining number of visits of a UGC by a server is provided. The server includes an interface module, an access module and a storage module. The set of instructions to direct at least one processor to perform acts of:

receiving, by the interface module, a querying request transmitted by a client for querying number of visits of a UGC, wherein the querying request carries an identifier of the UGC;

obtaining, by the interface module, the number of visits of the UGC from the storage module according to the identifier of the UGC; wherein the number of visits of the UGC is stored in the storage module and is updated according to UGC number-of-visits information of the UGC generated by the access module, the access module generates the UGC number-of-visits information according to UGC retrieving action information obtained from a background server of a UGC system; and

returning, by the interface module, the obtained number of visits of the UGC to the client, such that the client displays the number of visits of the UGC in association with the UGC.

Other aspects or embodiments of the present disclosure can be understood by those skilled in the art in light of the description, the claims, and the drawings of the present disclosure.

### BRIEF DESCRIPTION OF THE DRAWINGS

Features of the present disclosure are illustrated by way of example and not limited in the following figures, in which like numerals indicate like elements, in which:

FIG. 1 is a schematic diagram illustrating an example embodiment of a computer system.

FIG. 2 is a schematic diagram illustrating a method for obtaining number of visits of a UGC at a server side according to an example of the present disclosure.

FIG. 3 is a schematic diagram illustrating a process of updating number of visits stored in a storage module according to an example of the present disclosure.

FIG. 4 is a schematic diagram illustrating a method for obtaining number of visits of a UGC at the server side according to another example of the present disclosure.

FIG. 5 is a schematic diagram illustrating a process of updating the number of visits stored in the storage module according to an example of the present disclosure.

FIG. 6 is a schematic diagram illustrating a method for obtaining number of visits of a UGC at the server side according to another example of the present disclosure.

FIG. 7 is a schematic diagram illustrating a method for obtaining number of visits of a UGC at a client side according to another example of the present disclosure.

FIG. 8 is a schematic diagram shows the display of the number of visits of a UGC according to an example of the present disclosure.

FIG. 9 is a schematic diagram illustrating a structure of a server for obtaining number of visits of a UGC according to an example of the present disclosure.

FIG. 10 is a schematic diagram illustrating a structure of a client for obtaining number of visits of a UGC according to an example of the present disclosure.

### DETAILED DESCRIPTION

The preset disclosure will be described in further detail hereinafter with reference to accompanying drawings and examples to make the technical solution and merits therein clearer.

For simplicity and illustrative purposes, the present disclosure is described by referring to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the term “includes” means includes but not limited to, the term “including” means including but not limited to. The term “based on” means based at least in part on. In addition, the terms “a” and “an” are intended to denote at least one of a particular element.

In a conventional UGC system, technical parameters for evaluating spread range of a UGC generally include forwarding times of the UGC, number of comments of the UGC, number of likes, etc. However, users having visited a UGC not always forward, comment, or like the UGC. In other words, visitors of a UGC are not merely those who have forwarded, commented or liked the UGC. Therefore, the spread range of a UGC cannot be evaluated accurately according to the forwarding times, number of comments or number of likes.

In contrast to this, in an example of the present disclosure, a client transmits to a server a querying request for querying number of visits of a UGC. The server obtains the number of visits of the UGC according to retrieved times of the UGC in a UGC system and provides the number of visits to the client. The client displays the number of visits of the UGC in association with the UGC. Thus, users can see the number of visits of the UGC explicitly. The number of visits of the UGC reflects visiting situations of the UGC. Compared with the conventional parameters such as forwarding times and number of comments, the number of visits of the UGC is able to reflect the spread range of the UGC more accurately.

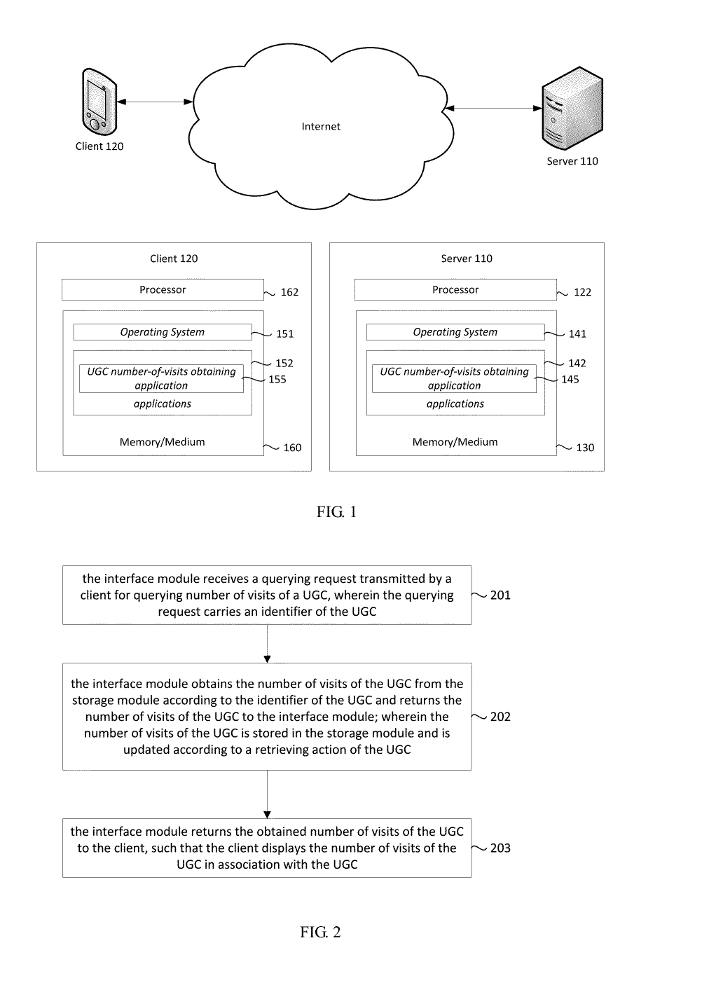

FIG. 1 is a schematic diagram illustrating a computer system according to an example of the present disclosure. As shown in FIG. 1, the computer system includes a server 110 and a client 120.

The server 110 may vary in terms of capabilities or features. Claimed subject matter is intended to cover a wide range of potential variations. For example, the server 110 may include or execute a variety of operating systems 141 and a variety of possible applications 142, such as a number-of-visits obtaining application 145.

Further, the server 110 may include one or more non-transitory processor-readable storage media 130 and one or more processors 122 in communication with the non-transitory processor-readable storage media 130.

The client 120 may, for example, be a device such as a personal desktop computer or a portable device, such as a laptop computer, a tablet computer, a cellular telephone, or a smart phone, etc. The client 120 may include a variety of operating systems 151 such as Android, Palm OS, Symbian, Windows mobile, Linux, iPhone OS, Black Berry OS 6.0, Windows Phone, etc.

The client 120 may execute a variety of possible applications 152, such as a number-of-visits obtaining application 155.

The client 120 may include one or more non-transitory processor-readable storage media 160 and one or more processors 162 in communication with the non-transitory processor-readable storage media 160.

In examples of the present disclosure, the non-transitory processor-readable storage media 130 and 160 may be a RAM memory, flash memory, ROM memory, EPROM memory, EEPROM memory, registers, hard disk, a removable disk, a CD-ROM, or any other form of non-transitory storage medium known in the art. The one or more non-transitory processor-readable storage media 130 and 160 may store sets of instructions, or units and/or modules that include the sets of instructions, for conducting operations described in the present disclosure. The one or more processors may be configured to execute the sets of instructions and perform the operations in examples of the present disclosure.

FIG. 2 is a schematic diagram illustrating a method for obtaining number of visits of a UGC at a server side according to an example of the present disclosed number-of-visits obtaining application 145. The server is configured with an access module, a storage module and an interface module. As shown in FIG. 2, the method includes the following.

At block 201, the interface module receives a querying request transmitted by a client for querying number of visits of a UGC, wherein the querying request carries an identifier of the UGC.

The interface module provides a querying service of the number of visits of the UGC, i.e., a reading service of the number of visits of the UGC. The querying request may be transmitted by the client under various trigger conditions. Once a trigger condition is met, a querying request is transmitted by the client to the interface module. For example, the querying request may be triggered when the UGC is visited. Or, a dedicated querying interface may be configured at the client. The querying request is triggered via the querying interface. The querying request transmitted by the client to the interface module includes the identifier of the UGC whose number of visits is to be queried. The querying request may further include information of the user who wants to query the number of visits (i.e., the user of the client).

At block 202, the interface module obtains the number of visits of the UGC from the storage module according to the identifier of the UGC; wherein the number of visits of the UGC is stored in the storage module and is updated according to a retrieving action of the UGC.

After receiving the querying request transmitted by the client, the interface module may transmit the querying request to the storage module. The storage module obtains the number of visits of the UGC according to the identifier of the UGC and returns the number of visits to the interface module.

In the UGC system, each time a UGC is displayed on a client, the UGC is retrieved for one time from a background server of the UGC system. Generally, one UGC retrieving action corresponds to one time UGC visiting. In some cases, for a UGC retrieving action triggered by a special account (e.g., a famous account), a weight m (m is an integer) may be applied. Thus, one retrieving action triggered by this account corresponds to m times of UGC visiting. Therefore, the number of visits of the UGC may be determined according to the number of retrieving actions of the UGC. Each time the UGC is retrieved, a piece of UGC retrieving action information is generated by the background server of the UGC system. The UGC retrieving action information generally includes: a distributor of the UGC, a distributed time of the UGC, a user who triggers the retrieving action, etc.

In this example, the access module of the server obtains the UGC retrieving action information from the background server of the UGC system, and converts the UGC retrieving action information into UGC number-of-visits information, i.e., generates UGC number-of-visits information according to the UGC retrieving action information. The access module transmits the generated UGC number-of-visits information to the storage module via a data packet. The UGC number-of-visits information may include an identifier of the UGC and number of visits of the UGC.

After receiving the UGC number-of-visits information transmitted by the access module, if the storage module has stored number of visits of the UGC corresponding to the UGC number-of-visits information, the storage module updates the number of visits stored in the storage module. If the storage module does not store number of visits of the UGC corresponding to the UGC number-of-visits information, the storage module stores the identifier of the UGC and the number of visits of the UGC included in the UGC number-of-visits information.

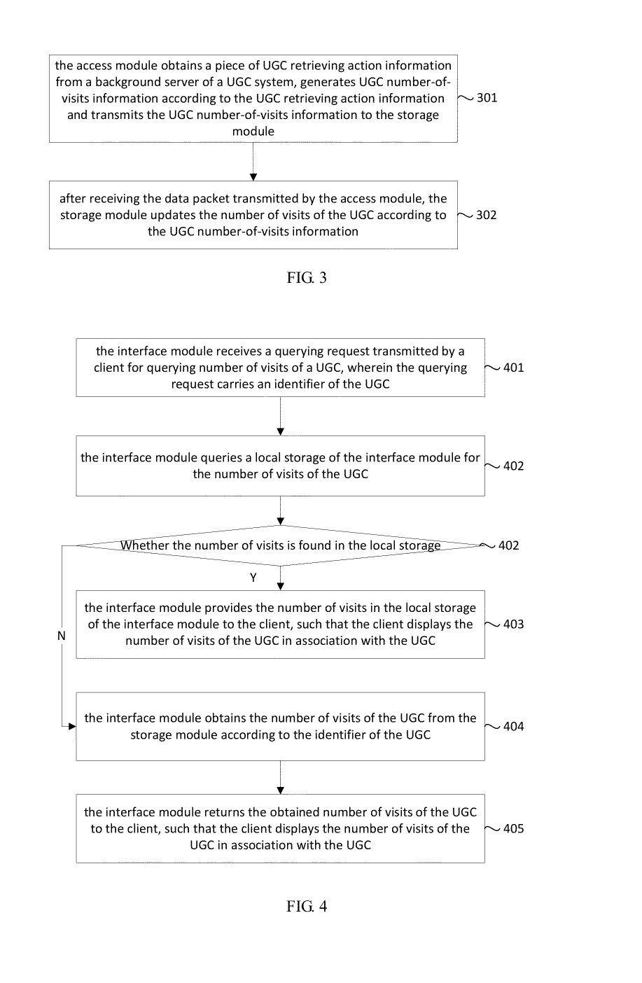

Hereinafter, the update of the number of visits of a UGC is described with reference to FIG. 3. As shown in FIG. 3, the process of updating the number of visits of the UGC includes the following.

At block 301, the access module obtains a piece of UGC retrieving action information from a background server of a UGC system, generates UGC number-of-visits information according to the UGC retrieving action information and transmits the UGC number-of-visits information to the storage module.

Since a UGC may be retrieved for many times during a time period, e.g., after the UGC is distributed, if the access module transmits the UGC number-of-visits information to the storage module each time the UGC is retrieved, there will be a lot of data packets transmitted to the storage module, which brings a heavy burden to the storage module. Therefore, a caching mechanism is applied to the access module, so as to decrease the number of data packets transmitted to the storage module.

In particular, after generating the UGC number-of-visits information, the access module caches the UGC number-of-visits information. If the amount of the cached the UGC number-of-visits information reaches a predefined value or the UGC number-of-visits information has been cached for a predefined time period, the access module puts the UGC number-of-visits information into a data packet and transmits the data packet to the storage module.

Hereinafter, three exemplary caching mechanisms of the access module are described.

In a first caching mechanism, if the number of UGCs corresponding to the UGC number-of-visits information cached by the access module reaches a predefined value, the access module transmits the cached UGC number-of-visits information to the storage module.

For example, the access module obtains 10 pieces of UGC retrieving action information of 4 microblog messages, wherein microblog message 1 is retrieved for one time, microblog message 2 is retrieved for 5 times, microblog message 3 is retrieved for 2 times and microblog message 4 is retrieved for 2 times. The access module may generate number-of-visits information according to the 10 pieces of UGC retrieving action information.

TABLE 1

| | Number of visits of the microblog |
|---|---|
| Microblog message ID | message |
| Microblog message 1 | 1 |
| Microblog message 2 | 5 |
| Microblog message 3 | 2 |
| Microblog message 4 | 2 |

In this example, suppose that one retrieving action corresponds to one time of visiting. Thus, the number of visits of microblog message 1 is 1, the number of visits of microblog message 2 is 5, the number of visits of microblog message 3 is 2, and the number of visits of microblog message 4 is 2. The 10 number of visits correspond to 4 microblog messages, e.g., microblog messages 1, 2, 3 and 4, as shown in table 1.

If the access module determines that the number of microblog messages corresponds to the cached UGC number-of-visits information reaches a predefined value (e.g., 100, i.e., 100 microblog messages with different IDs are cached), the access module combines the cached number-of-visits information into a data packet and transmits the data packet to the storage module. The data packet includes the UGC number-of-visits information as shown in table 1, i.e., microblog message IDs, and number of visits corresponding to the microblog message IDs.

In a second caching mechanism, if a total number of visits of the UGCs reaches a predefined value, the access module combines the cached UGC number-of-visits information into a data packet and transmits the data packet to the storage module.

For example, still suppose that the access module receives 10 pieces of retrieving action information and generates the UGC number-of-visits information as shown in table 1. The access module adds the number of visits of all microblog messages (i.e., 1+5+2+2). If the total number of visits reaches a predefined value (e.g., 1000), the access module combines the cached number-of-visits information into a data packet and transmits the data packet to the storage module. The data packet includes the UGC number-of-visits information as shown in table 1, i.e., includes the microblog message IDs and the number of visits corresponding to the microblog message IDs.

In a third caching mechanism, if the UGC number-of-visits information has been cached by the access module for a predefined time period, the access module transmits the cached UGC number-of-visits information to the storage module via a data packet. Through the third caching mechanism, the UGC number-of-visits information may be transmitted to the storage module in time.

The third caching mechanism may be used in combination with any one of the first and second caching mechanisms.

In one example, in order to increase reading/writing efficiency of the number of visits of the UGCs, the UGCs are divided into different number ranges according to IDs of the UGCs. Each number range corresponds to at least one storage module which stores the number of visits of the UGCs within the number range.

At this time, the transmitting the UGC number-of-visits information to the storage module includes: if the amount of number-of-visits information of UGCs in the same number range reaches a predefined value or the UGC number-of-visits information of UGCs in the same number range has been cached for a predefined time period, the access module puts the UGC number-of-visits information into a data packet and transmits the data packets to the storage module.

At block 302, after receiving the data packet transmitted by the access module, the storage module updates the number of visits of the UGC according to the UGC number-of-visits information.

Suppose that the storage module receives a data packet including the UGC number-of-visits information as shown in table 1. The storage module adds the number of visits of each microblog message (i.e., microblog messages 1, 2, 3, 4) carried in the data packet to stored numbers of visits of these microblog messages. For example, the number of visits of microblog message 1 stored in the storage module is 100. Thus, the added result is 100+1=101. The number of visits of microblog message 2 stored in the storage module is 0. The added result of microblog message 2 is 0+5=5. The number of visits of microblog message 3 stored in the storage module is 40. The added result of microblog message 3 is 40+2=42. The number of visits of microblog message 4 stored in the storage module is 30. The added result of microblog message 4 is 30+2=32. Therefore, the storage module respectively updates the stored numbers of visits of microblog messages 1, 2, 3 and 4 to 101, 5, 42 and 32.

Through the above blocks 301 and 302, the numbers of visits of the UGCs stored in the storage module are updated along with the retrieving actions of the UGCs.

Thus, after receiving the querying request transmitted by the client, the interface module transmits the querying request to the storage module. The storage module obtains the number of visits of the UGC according to the identifier of the UGC and returns the number of visits to the interface module.

At block 203, the interface module returns the obtained number of visits of the UGC to the client, such that the client displays the number of visits of the UGC in association with the UGC.

The client may display the number of visits of the UGC in association with the UGC, e.g., below the text of the UGC (see 802 in FIG. 8). Thus, users can see the number of visits of the UGC explicitly. The number of visits of the UGC reflects visiting situations of the UGC. Compared with the conventional parameters such as forwarding times and number of comments, the number of visits of the UGC is able to reflect the spread range of the UGC more accurately.

In the UGC system, if a UGC is visited for a large number of times, the UGC becomes a hot UGC. For the hot UGC, many users may visit the hot UGC within a short time period, which refers to as a hot spot effect. In one example, with respect to the hot UGC, a hot caching mechanism is applied in the interface module. According to the hot caching mechanism, after obtaining the number of visits of a UGC from the storage module, the interface module caches the number of visits for a time period in a local storage of the interface module.

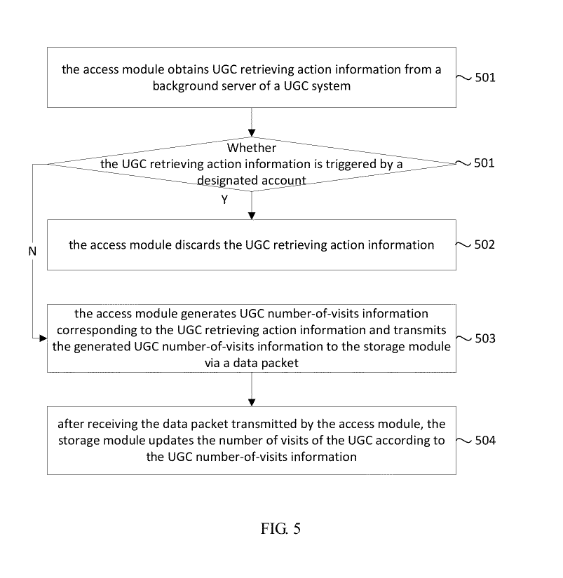

FIG. 4 is a flowchart illustrating a method for obtaining number of visits of a UGC according to an example of the present disclosure. In this example, the hot caching mechanism is applied in the interface module. As shown in FIG. 4, the method includes the following.

At block 401, the interface module receives a querying request transmitted by a client for querying number of visits of a UGC, wherein the querying request carries an identifier of the UGC.

This block is similar as block 201 and will not be repeated herein.

At block 402, after receiving the querying request, the interface module queries a local storage of the interface module for the number of visits of the UGC. If the number of visits of the UGC is found, block 403 is performed; otherwise, block 404 is performed.

At block 403, the interface module provides the number of visits in the local storage of the interface module to the client, such that the client displays the number of visits of the UGC in association with the UGC.

At block 404, the interface module obtains the number of visits of the UGC from the storage module according to the identifier of the UGC.

At block 405, the interface module returns the obtained number of visits of the UGC to the client, such that the client displays the number of visits of the UGC in association with the UGC.

Blocks 404 and 405 are respectively similar as blocks 202 and 203 and are not repeated herein.

According to an experiment, after the hot caching mechanism is adopted, over 20% number of visits can be obtained from the local storage of the interface module, which reduces reading operations from the storage module and reduces overhead of the storage module. At the same time, the distributing efficiency of the number of visits of the UGC is increased.

In the above examples, in order to ensure data security, with respect to each storage module, a backup storage module may be configured. Similarly with the storage module, the backup storage module receives the UGC number-of-visits information transmitted by the access module, updates the number of visits according to the UGC number-of-visits information. If a storage module fails to operate normally, reading/writing operations are switched to the backup storage module corresponding to the failed storage module.

In a UGC system, a UGC is usually visible to all users including the author (i.e., distributor) of the UGC. However, the statistic of the number of visits of the UGC should not include the author himself. In addition, there are also some malicious or fake accounts. Retrieving actions of these malicious or fake accounts should also be filtered, so as to make the number of visits of the UGC more accurate.

FIG. 5 is a schematic diagram illustrating update of number of visits of a UGC according to an example of the present disclosure. Compared with the updating process as shown in FIG. 3, in this example, retrieving actions triggered by some designated accounts (e.g., the author, fake accounts, third party accounts) are filtered. As shown in FIG. 5, the method includes the following.

At block 501, the access module obtains UGC retrieving action information from a background server of a UGC system and determines whether the UGC retrieving action information is triggered by a designated account. If the retrieving action information is triggered by a designated account, block 502 is performed; otherwise, block 503 is performed.

As described above, the UGC retrieving action information includes information such as the distributor of the UGC, the distributed time, and the user who triggers the retrieving action. Therefore, in this block, the access module may obtain the user who triggers the retrieving action from the UGC retrieving action information and compare the user with the designated account. If the user is the designated account, block 502 is performed; otherwise, block 503 is performed.

At block 502, the access module discards the UGC retrieving action information, i.e., does not generate UGC number-of-visits information for this piece of UGC retrieving action information.

At block 503, the access module generates UGC number-of-visits information corresponding to the UGC retrieving action information and transmits the generated UGC number-of-visits information to the storage module via a data packet.

At block 504, after receiving the data packet transmitted by the access module, the storage module updates the number of visits of the UGC according to the UGC number-of-visits information.

Blocks 503 and 504 are similar as blocks 302 and 303 as shown in FIG. 3 and will not be repeated herein.

Through this example, retrieving actions of the author, the malicious or fake accounts are filtered and the number of visits of the UGC becomes more accurate.

In the UGC system, the number of visits of UGCs distributed by some official accounts may be private data of the official account. Thus, the number of visits of these UGCs should not be seen by public users.

In one example, a private identifier may be configured for the number of visits of a designated account who does not wish public users see the number of visits. Specifically, after obtaining the UGC retrieving action information, the access module may determine whether the UGC retrieving action information corresponds to the designated account. If yes, the access module adds a private identifier to the UGC number-of-visits information of the designated account and transmits the UGC number-of-visits information including the private identifier to the storage module. After receiving the UGC number-of-visits information including the private identifier, the storage module updates the stored number of visits of the UGC and adds a private identifier to the number of visits of the UGC corresponding to the designated account.

Thus, after receiving a querying request, the interface module may determine, according to the number of visits cached in the interface module or the number of visits stored in the storage module, whether the number of visits has the private identifier.

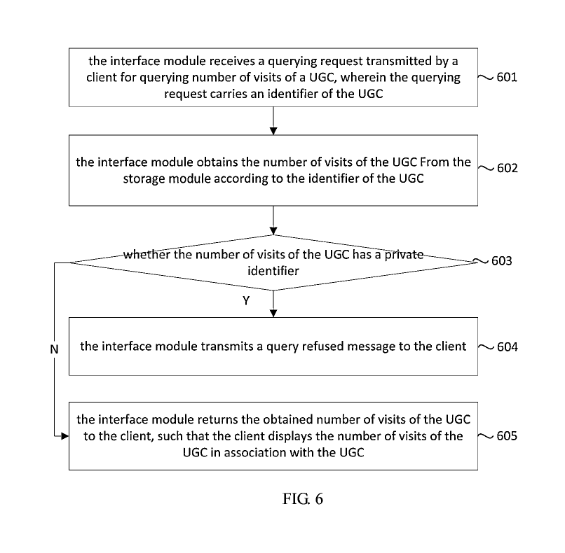

FIG. 6 is a flowchart illustrating a method for obtaining number of visits of a UGC according to an example of the present disclosure. As shown in FIG. 6, the method includes the following.

At block 601, the interface module receives a querying request transmitted by a client for querying number of visits of a UGC, wherein the querying request carries an identifier of the UGC.

This block is similar as block 201 and is not repeated herein.

At block 602, the interface module obtains the number of visits of the UGC from the storage module according to the identifier of the UGC.

This block is similar as block 202 and is not repeated herein.

At block 603, the interface module determines whether the number of visits obtained from the storage module has a private identifier. If yes, block 604 is performed; otherwise, block 605 is performed.

At block 604, the interface module transmits a query refused message to the client, indicating that the querying of the number of visits of the account is refused.

At block 605, the interface module returns the obtained number of visits of the UGC to the client, such that the client displays the number of visits of the UGC in association with the UGC.

This block is similar as block 203 and is not repeated herein.

Through the above examples, users can see the number of visits of the UGC explicitly. The number of visits of the UGC reflects visiting situations of the UGC. Compared with the conventional parameters such as forwarding times and number of comments, the number of visits of the UGC is able to reflect the spread range of the UGC more accurately.

Besides displaying the number of visits of the UGC, information about visitors of the UGC may also be displayed. At this time, after obtaining the UGC retrieving action information from the background server of the UGC system, the access module generates UGC number-of-visits information and UGC visitor information according to the UGC retrieving action information and transmits the generated UGC number-of-visits information and the UGC visitor information to the storage module. The UGC visitor information includes an ID of a visitor of the UGC and a visited time. After receiving the UGC number-of-visits information and the UGC visitor information, the storage module updates the stored number of visits of the UGC and the visitor information of the UGC.

When desiring to see the visitor information of a UGC, the user triggers a UGC visitor information querying request to the interface module, wherein the UGC visitor information querying request carrying an identifier of the UGC. After receiving the UGC visitor information querying request, the interface module obtains the visitor information corresponding to the identifier of the UGC from the storage module or from the local storage and returns the obtained visitor information to the client.

The number segment and the caching mechanisms (e.g., the caching mechanisms of the access module, the hot caching mechanism of the interface module) are also applicable for the visitor information.

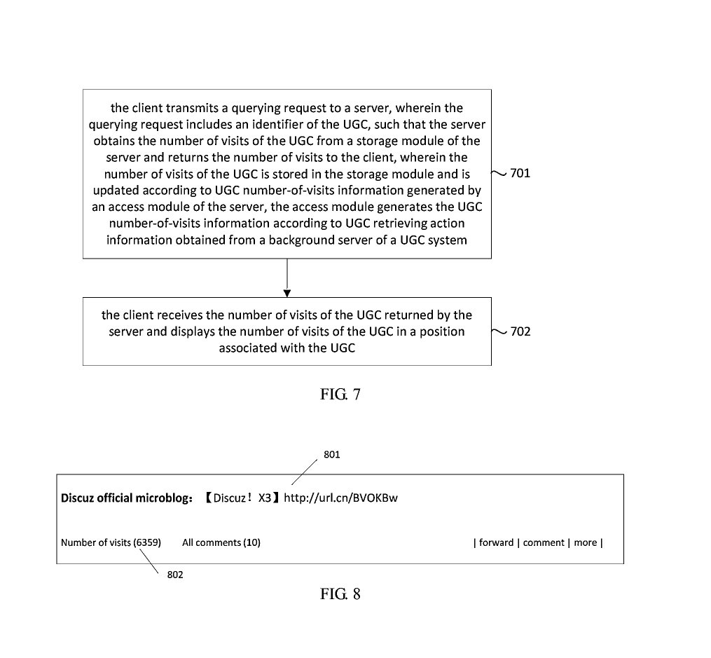

FIG. 7 is a schematic diagram illustrating a method for obtaining number of visits of a UGC at a client end according to an example of the present disclosed number-of-visits obtaining application 155.

As shown in FIG. 7, the method includes at least the following processes.

At block 701, the client transmits a querying request to a server, wherein the querying request includes an identifier of the UGC, such that the server obtains the number of visits of the UGC from a storage module of the server and returns the number of visits to the client, wherein the number of visits of the UGC is stored in the storage module and is updated according to UGC number-of-visits information generated by an access module of the server, the access module generates the UGC number-of-visits information according to UGC retrieving action information obtained from a background server of a UGC system.

At block 702, the client receives the number of visits of the UGC returned by the server and displays the number of visits of the UGC in a position associated with the UGC.

The position associated with the UGC may be a position which can differentiate one UGC with another UGC, i.e., a user is able to determine that the position belongs to this UGC explicitly. Generally, the associated position may be any side of the UGC or below the UGC. FIG. 8 is a schematic diagram illustrating displaying the number of visits of a UGC on the associated position according to an example of the present disclosure. As shown in FIG. 8, the number of visits of the UGC 801 is displayed on an associated position 802 below the UGC 801. The “number of visits” 802 may also be expressed by “visited times” or other similar phrases.

In one example, the method may further include: when the UGC is updated (i.e., the user issues a UGC update instruction), the client transmits a querying request carrying the identifier of the UGC to the server, and receives a newest querying result about the UGC number of visits from the background server, and updates the displayed number of visits (e.g., “6359” displayed following “number of visits” in FIG. 8) of the UGC by the querying result received.

In another example, the method further includes: if a time period (e.g., 2-5 seconds) elapses after the UGC is updated, the client transmits a querying request carrying the identifier of the UGC to the server, receives a newest querying result of the number of visits of the UGC, and updates the displayed number of visits of the UGC according to the querying result.

In another example, the method may further include: the client transmits a UGC visitor information querying request carrying the identifier of the UGC to the server, receives a querying result of the UGC visitor information, and displays the UGC visitor information on the associated position where the UGC number of visits is displayed.

For example, when the UGC is loaded and displayed, the number of visits of the UGC is displayed. After an instruction for displaying the UGC visitor information is triggered, the UGC visitor information is displayed on the associated position where the number of visits is displayed. The user may trigger the instruction for displaying the UGC visitor information through clicking on the associated position where the number of visits is displayed. Or, the instruction may be triggered when a mouse of the user is placed on the associated position. The UGC visitor information may be a list of information of every visitor who has read the UGC, e.g., ID of the visitor, visited time, etc.

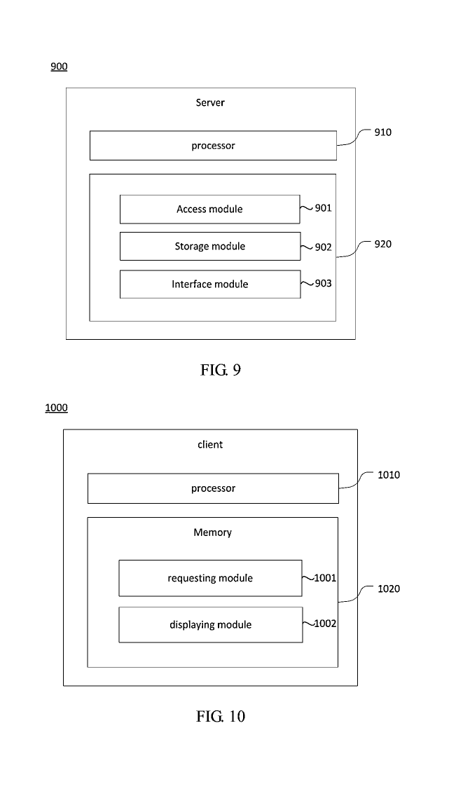

In accordance with the above method examples, an example of the present disclosure provides a server 900 for obtaining number of visits of a UGC. As shown in FIG. 9, the server includes:

one or more processors 910;

a memory 920;

wherein one or more program modules are stored in the memory 920 and to be executed by the one or more processors 910, the one or more program modules include:

an access module 901, adapted to obtain UGC retrieving action information from a background server of a UGC system, generate UGC number-of-visits information according to the UGC retrieving action information and transmit the generated UGC number-of-visits information to a storage module; wherein the UGC number-of-visits information includes an identifier of the UGC and number of visits of the UGC;

the storage module 902, adapted to receive the UGC number-of-visits information transmitted by the access module 901, and update number of visits of the UGC stored in the storage module according to the UGC number-of-visits information; and

an interface module 903, adapted to receive a querying request carrying the identifier of the UGC from a client, obtain the number of visits of the UGC from the storage module according to the identifier of the UGC, and returns the number of visits to the client, such that the client displays the number of visits of the UGC in association with the UGC.

Other functions and operations of the above server 900 may be obtained from the above method examples and will not be repeated herein.

FIG. 10 is a schematic diagram illustrating a client for obtaining number of visits of a UGC according to an example of the present disclosure. As shown in FIG. 10, the client 1000 includes:

one or more processors 1010;

a memory 1020;

wherein one or more program modules are stored in the memory 1020 and to be executed by the one or more processors 1010, the one or more program modules include:

a requesting module 1001, adapted to transmit a querying request to a server, such that the server obtains the number of visits of the UGC from a storage module of the server and returns the number of visits to the client, wherein the number of visits of the UGC is stored in the storage module and is updated according to UGC number-of-visits information generated by an access module of the server, the access module generates the UGC number-of-visits information according to UGC retrieving action information obtained from a background server of a UGC system; and

a displaying module 1002, adapted to receive the number of visits of the UGC returned by the server and display the number of visits of the UGC in a position associated with the UGC.

Other functions and operations of the above client 1000 may be obtained from the above method examples and will not be repeated herein.

The processor in the examples of the present disclosure may include one or more processors for executing the sets of instructions stored in the memory. The processor is a hardware device, such as a central processing unit (CPU) or a micro controlling unit (MCU). The memory in the examples of the present disclosure is a non-transitory processor-readable storage media, such as a RAM memory, flash memory, ROM memory, EPROM memory, EEPROM memory, registers, hard disk, a removable disk, a CD-ROM, or any other form of non-transitory storage medium known in the art.

What has been described and illustrated herein is a preferred example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. A method for obtaining number of visits of a user generated content (UGC) by a server, wherein the server comprises an interface module, an access module and a storage module, the method comprises:
receiving, by the interface module, a querying request transmitted by a client for querying number of visits of a UGC, wherein the querying request carries an identifier of the UGC;
obtaining, by the interface module, the number of visits of the UGC from the storage module according to the identifier of the UGC; wherein the number of visits of the UGC is stored in the storage module and is updated according to UGC number-of-visits information of the UGC generated by the access module, the access module generates the UGC number-of-visits information according to UGC retrieving action information obtained from a background server of a UGC system; and
returning, by the interface module, the obtained number of visits of the UGC to the client, such that the client displays the number of visits of the UGC in association with the UGC.

2. The method of claim 1, further comprising:
after obtaining the number of visits of the UGC from the storage module, caching, by the interface module, the number of visits of the UGC in a local storage of the interface module.

3. The method of claim 2, further comprising:
before obtaining the number of visits of the UGC according to the identifier of the UGC from the storage module,
determining, by the interface module, whether the number of visits of the UGC is stored in the local storage of the interface module;
if the number of visits of the UGC is stored in the local storage of the interface module, obtaining, by the interface module, the number of visits of the UGC from the local storage of the interface module;
otherwise, performing the process of obtaining the number of visits of the UGC from the storage module.

4. The method of claim 1, further comprising:
generating, by the access module, the UGC number-of-visits information according to the UGC retrieving action information; wherein the UGC retrieving action information comprises a distributor of the UGC, a distributed time of the UGC, and a user who triggers a retrieving action of the UGC; the UGC number-of-visits information comprises the identifier of the UGC and the number of visits of the UGC;
transmitting, by the access module, the UGC number-of-visits information to the storage module via a data packet; and
updating, by the storage module, the number of visits of the UGC stored in the storage module according to the UGC number-of-visits information carried in the data packet.

5. The method of claim 4, further comprising:
before transmitting the UGC number-of-visits information to the storage module, caching, by the access module, the generated UGC number-of-visits information;
wherein the transmitting the UGC number-of-visits information to the storage module via the data packet comprises:
determining, by the access module, whether the amount of the cached UGC number-of-visits information reaches a predefined value and/or whether the UGC number-of-visits information has been cached for a predefined time period;
if the amount of the cached UGC number-of-visits information reaches the predefined value and/or whether the UGC number-of-visits information has been cached for the predefined time period, generating, by the access module, the data packet containing the cached UGC number-of-visits information, and transmitting the data packet to the storage module.

6. The method of claim 4, further comprising:
before generating the UGC number-of-visits information corresponding to the UGC retrieving action information, determining, by the access module, whether the UGC retrieving action information is triggered by a designated account;
if the UGC retrieving action information is triggered by the designated account, the access module discarding the UGC retrieving action information; otherwise, performing the process of generating the UGC number-of-visits information according to the UGC retrieving action information.

7. The method of claim 4, further comprising:
before generating the UGC number-of-visits information corresponding to the UGC retrieving action information, determining, by the access module, whether the UGC retrieving action information is triggered by a designated account;
if the UGC retrieving action information is triggered by the designated account,
adding, by the access module, a private identifier to the generated UGC number-of-visits information;
adding, by the storage module after updating the number of visits of the UGC stored in the storage module, the private identifier to the number of visits corresponding to the designated account in the storage module.

8. The method of claim 7, further comprising:
before returning the obtained number of visits of the UGC to the client, determining, by the interface module, whether the number of visits returned by the storage module has the private identifier;
if the number of visits returned by the storage module has the private identifier, transmitting, by the interface module, a query refused message to the client; otherwise, performing the process of returning the number of visits of the UGC to the client.

9. The method of claim 4, further comprising:
after obtaining the UGC retrieving action information from the background server of the UGC system, generating, by the access module, UGC visitor information according to the UGC retrieving action information, wherein the UGC visitor information comprises information of a visitor of the UGC and a visited time of the visitor;
transmitting, by the access module, the UGC visitor information to the storage module; and
updating, by the storage module, visitor information stored in the storage module according to the UGC visitor information received.

10. The method of claim 9, further comprising:
receiving, by the interface module, a UGC visitor information querying request transmitted by the client for querying the UGC visitor information, wherein the UGC visitor information querying request carries the identifier of the UGC;
obtaining, by the interface module, the UGC visitor information according to the identifier of the UGC from the storage module; and
returning, by the interface module, the obtained UGC visitor information to the client, such that the client displays the UGC visitor information in association with the UGC.

11. A server for obtaining number of visits of a user generated content (UGC), comprising:
one or more processors;
a memory; and
one or more program modules stored in the memory and to be executed by the one or more processors, the one or more program modules comprise:
an access module, adapted to obtain UGC retrieving action information, generate number-of-visits information according to the UGC retrieving action information and transmit the generated UGC number-of-visits information to a storage module; wherein the UGC number-of-visits information comprises an identifier of the UGC and number of visits of the UGC;
the storage module, adapted to receive the UGC number-of-visits information transmitted by the access module, and update number of visits of the UGC stored in the storage module according to the UGC number-of-visits information; and
an interface module, adapted to receive a querying request carrying the identifier of the UGC from a client, obtain the number of visits of the UGC from the storage module according to the identifier of the UGC, and return the number of visits to the client, such that the client displays the number of visits of the UGC in association with the UGC.

12. The server of claim 11, wherein the interface module is further adapted to:
determine, before obtaining the number of visits of the UGC from the storage module, whether the number of visits of the UGC is stored in a local storage of the interface module;
obtain, if the number of visits of the UGC is stored in the local storage of the interface module, the number of visits of the UGC from the local storage of the interface module; and
obtain the number of visits of the UGC from the storage module if otherwise.

13. The server of claim 11, wherein the UGC retrieving action information comprises a distributor of the UGC, a distributed time of the UGC, and a user who triggers a retrieving action of the UGC; the UGC number-of-visits information comprises the identifier of the UGC and the number of visits of the UGC.

14. The server of claim 11, wherein the access module is further adapted to:
cache the generated number-of-visits information after generating the UGC number-of-visits information corresponding to the UGC retrieving action information;
determine whether the amount of the cached UGC number-of-visits information reaches a predefined value and/or whether the UGC number-of-visits information has been cached for a predefined time period;
generate, if the amount of the cached UGC number-of-visits information reaches the predefined value and/or whether the UGC number-of-visits information has been cached for the predefined time period, a data packet containing the cached UGC number-of-visits information; and
transmit the data packet to the storage module.

15. The server of claim 11, wherein the access module is further adapted to:
determine, before generating the UGC number-of-visits information corresponding to the UGC retrieving action information, whether the UGC retrieving action information is triggered by a designated account;
discard the UGC retrieving action information if the UGC retrieving action information is triggered by the designated account; and
generate the UGC number-of-visits information corresponding to the UGC retrieving action information if otherwise.

16. The server of claim 11, wherein
the access module is further adapted to:
determine, after obtaining the UGC retrieving action information from the background server of the UGC system, whether the UGC retrieving action information is triggered by a designated account; and
add, if the UGC retrieving action information is triggered by the designated account, a private identifier to the generated UGC number-of-visits information;
the storage module is further adapted to:
add, after updating the number of visits of the UGC stored in the storage module according to the UGC number-of-visits information, the private identifier to the number of visits corresponding to the designated account in the storage module.

17. The server of claim 16, wherein the interface module is further adapted to:
determine, before returning the obtained number of visits of the UGC to the client, whether the number of visits returned by the storage module has the private identifier;
transmit, if the number of visits returned by the storage module has the private identifier, a query refused message to the client; and
return the number of visits of the UGC to the client if otherwise.

18. The server of claim 11, wherein
the access module is further adapted to:
generate, after obtaining the UGC retrieving action information from the background server of the UGC system, UGC visitor information according to the UGC retrieving action information, wherein the UGC visitor information comprises information of a visitor of the UGC and a visited time of the visitor; and
transmit the UGC visitor information to the storage module;
the storage module is further adapted to:
update visitor information stored in the storage module according to the UGC visitor information received.

19. The server of claim 18, wherein the interface module is further adapted to:
receive a UGC visitor information querying request transmitted by the client for querying the UGC visitor information, wherein the UGC visitor information querying request carries the identifier of the UGC;
obtain the UGC visitor information according to the identifier of the UGC from the storage module; and
return the obtained UGC visitor information to the client, such that the client displays the UGC visitor information in association with the UGC.

20. A non-transitory computer-readable storage medium comprising a set of instructions for obtaining number of visits of a user generated content (UGC) by a server, wherein the server comprises an interface module, an access module and a storage module, the set of instructions to direct at least one processor to perform acts of:
receiving, by the interface module, a querying request transmitted by a client for querying number of visits of a UGC, wherein the querying request carries an identifier of the UGC;
obtaining, by the interface module, the number of visits of the UGC from the storage module according to the identifier of the UGC; wherein the number of visits of the UGC is stored in the storage module and is updated according to UGC number-of-visits information of the UGC generated by the access module, the access module generates the UGC number-of-visits information according to UGC retrieving action information obtained from a background server of a UGC system; and
returning, by the interface module, the obtained number of visits of the UGC to the client, such that the client displays the number of visits of the UGC in association with the UGC.
